(19) United States
(12) Patent Application Publication
(10) Pub. No.: US 2016/0147918 A1
(43) Pub. Date: May 26, 2016

(54) METHOD AND LOAD ANALYSIS FOR MULTI-OFF-CENTER TOOLS

(71) Applicant: LANDMARK GRAPHICS CORPORATION, Houston, TX (US)

(72) Inventors: Robello Samuel, Cypress, TX (US); Yuan Zhang, Missouri City, TX (US); Aniket N/A, Houston, TX (US)

(21) Appl. No.: 14/786,236

(22) PCT Filed: Sep. 25, 2013
(86) PCT No.: PCT/US2013/061683

§ 371 Date: Oct. 22, 2015

(51) Int. Cl. G06F 17/50; G06F 17/10

(52) U.S. Cl. CPC G06F 17/5009; G06F 17/10

(57) ABSTRACT

Various embodiments include apparatus and methods to perform a load analysis for multi-off-center tools. Off-center components of a completion string experience additional downhole side and drag forces due to contact with casing and liner walls which may lead to excessive loading and stresses leading to failures. Systems and techniques are provided to analyze such situations. Additional apparatus, systems, and methods are disclosed.

### TECHNICAL FIELD

The present invention relates generally to apparatus and methods related to measurements and analysis of data.

### BACKGROUND

Advancement in multiple zone completion has been quite rapid in recent years, but multiple zone completion poses numerous operational challenges that adversely affect the efficiency of the completion process. Completion generally refers to the group of downhole tubulars and equipment that provide for enablement of safe and efficient production from an oil or gas well. With increasingly complex wellbore geometries, advanced completion tools are run in together to maximize reservoir productivity. Due to their design requirements, some components in the completion string are not concentric with the wellbore but are off-centered or eccentric. Running in of these off-centered tools generates additional loads on the completion string that need to be accounted for. The problems experienced while running these completion strings include increased torque and drag, buckling or a combination of both. Current methods are not modeled properly and severely underestimate stress values and pick-up loads when completion strings are run in. In addition, hole sizes vary frequently while drilling a well requiring various sized casings or liners to reach the target depth, which in turn result in higher loads on the completion string.

### BRIEF DESCRIPTION OF THE DRAWINGS

FIG. 1 shows an example of a component string balance, in accordance with various embodiments.

FIG. 2A shows an example of a completion string in which the completion string undergoes a bending, in accordance with various embodiments.

FIG. 2B shows the bending of FIG. 2A, with associated moment and side force, with respect to a component at an interface between two casings, in accordance with various embodiments.

FIG. 3 shows an example of a completion string under various conditions with respect to four symmetric components and an eccentric component, in accordance with various embodiments.

FIG. 4 shows a representation of displacements of three components experiencing a side force, in accordance with various embodiments.

FIG. 5 shows a five component model in which an eccentric component is located as a center component in the sequence of components with two symmetric components on each side of the eccentric component, in accordance with various embodiments.

FIG. 6 shows a representation of the model of FIG. 5 with respect to bending angle of the completion string at each component, in accordance with various embodiments.

FIG. 7 illustrates friction force in a single direction for a five component model, in accordance with various embodiments.

FIG. 8 depicts a block diagram of features of an example system operable to perform load analysis with respect to multiple off-center components, in accordance with various embodiments.

FIG. 9 shows features of an example overview approach to analysis of a component string to determine a minimum displacement of the components, in accordance with various embodiments.

FIG. 10 depicts an embodiment of a system at a drilling site, where the system is operable to perform load analysis with respect to multiple off-center components, in accordance with various embodiments.

### DETAILED DESCRIPTION

The following detailed description refers to the accompanying drawings that show, by way of illustration and not limitation, various embodiments in which the invention may be practiced. These embodiments are described in sufficient detail to enable those skilled in the art to practice these and other embodiments. Other embodiments may be utilized, and structural, logical, and electrical changes may be made to these embodiments. The various embodiments are not necessarily mutually exclusive, as some embodiments can be combined with one or more other embodiments to form new embodiments. The following detailed description is, therefore, not to be taken in a limiting sense.

Deepwater drilling to develop pre-salt reservoirs requires very complex drilling and completion programs. Multiple expensive tools and components that may be concentric or off-center with the wellbore are run in the drilling and completion strings to successfully access and develop these complex reservoirs. Off-center components experience additional downhole side and drag forces due to contact with casing and liner walls which may lead to excessive loading and stresses leading to failures. Running in of some of these off-center tools and components in the completion strings have led to failures and loss of the string itself due to downhole forces observed that had not been accounted for accurately. Modeling and accurately estimating the side and drag forces along with the minimum distance between the components in off-center strings to prevent failures would certainly prevent future loss of components

In various embodiments, load, side force, drag force and placement distance between multiple off-center tools is being estimated. Methods, as taught herein, can provide an estimation of side forces along off-center and concentric components and a minimum distance needed in between the components to run without failure. Distributed measurement against the formations can be conducted with respect to the following variables: axial strain, radial strain, bending moment, and displacement.

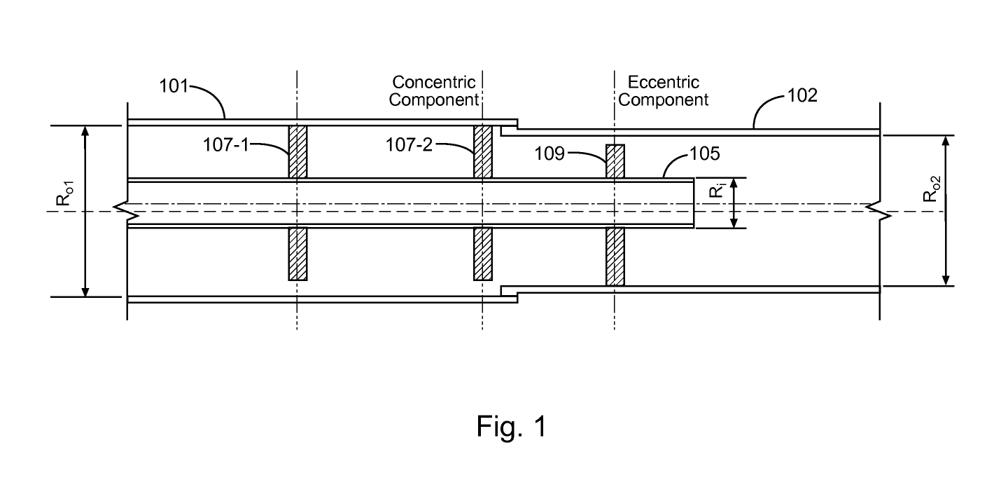

FIG. 1 shows an example of a component string balance. In this case, an eccentric component is run into reduced-size casing. As used herein, Rᵢ equals the outer radius of a completion string, Rₒ₁ equals the inner radius of a first casing 101, and Rₒ₂ equals the inner radius of a second casing 102, where the first casing 101 is larger than the second casing 102. FIG. 1 shows two concentric components 107-1, 107-2 and an eccentric component 109 with respect to a completion string 105 having an outer radius of Rᵢ. The technique, discussed herein, can be used with any number of concentric components and eccentric components.

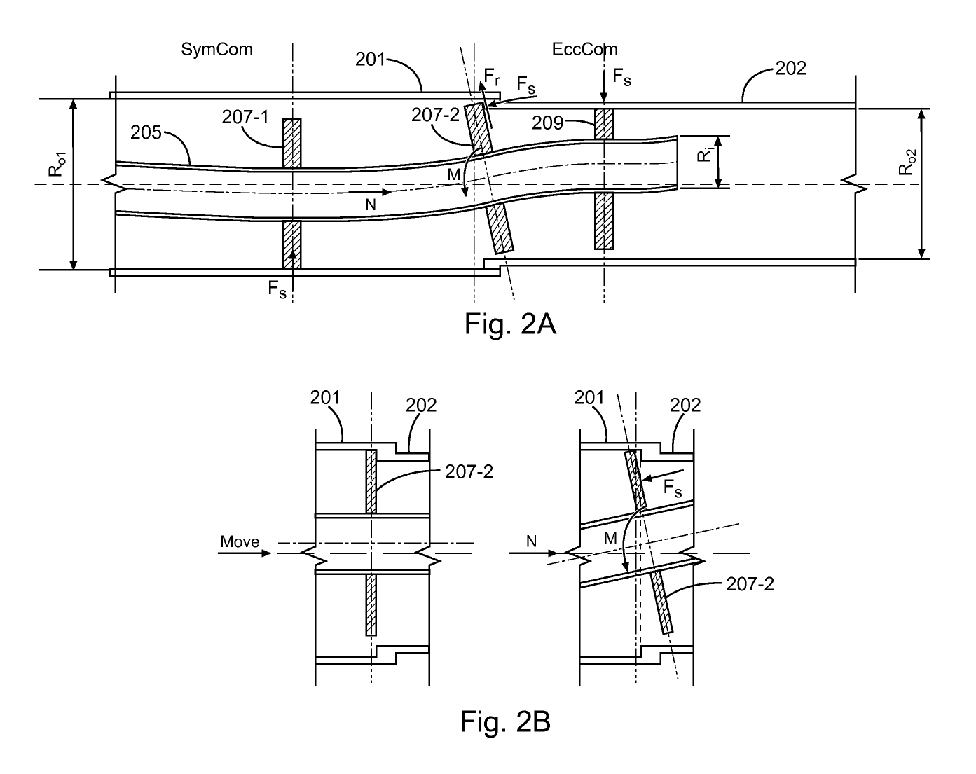

FIG. 2A shows an example of a completion string 205 in which the completion string 205 undergoes a bending. Completion string 205, having outer radius Rᵢ, is run in a first casing 201, having inner radius Rₒ₁, coupled to a second casing 202, having inner radius Rₒ₂, where Rₒ₁>Rₒ₂. An axial force, N, acts on completion string 205 and a side force Fₛ acts on each of concentric components 207-1, 207-2, and eccentric component 209. For ease of presentation, side force Fₛ is shown by the same variable at each location. However, the side forces at different components can be different, related to each other by an overall balancing condition. The bending of the completion string 205 generates a moment M acting on component 207-2, which is also accompanied by a friction force Fᵣ acting on the completion string 205. The technique, discussed herein, can be used with any number of concentric components and eccentric components. FIG. 2B shows the bending, with associated moment M and side force F with respect to component 207-2 at an interface between first casing 201 and the second casing 202, as an axial force is associated with the moving of the axis of the completion string 205 away from being parallel with the axis of the wellbore center.

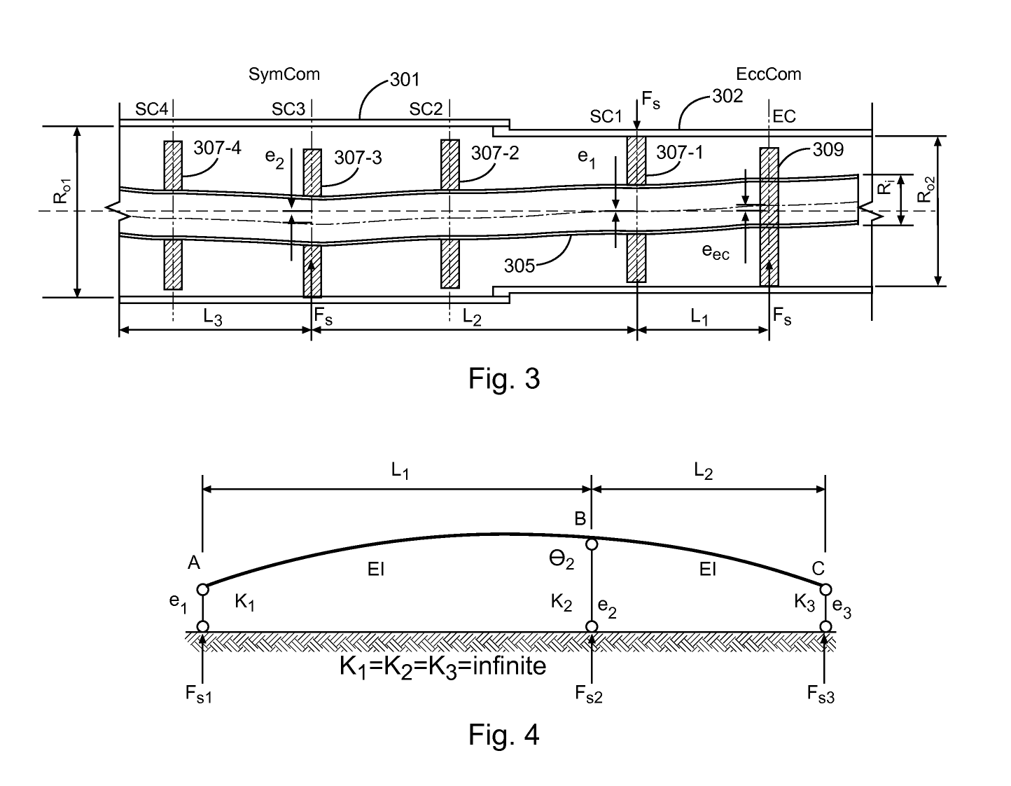

FIG. 3 shows an example of a completion string 305 under various conditions with respect to four symmetric components 307-1, 307-2, 307-3, and 307-4 and an eccentric component 309. Completion string 305, having outer radius Rᵢ, is run in a first casing 301, having inner radius Rₒ₁, coupled to a second casing 302, having inner radius Rₒ₂, where Rₒ₁>Rₒ₂. A side force Fₛ acts on the eccentric component 309 and each of the symmetric components 307-1 and 307-3 of the set of symmetric components 307-1, 307-2, 307-3, and 307-4. For ease of presentation, side force Fₛ is shown by the same variable at each location. However, the side forces at different components can be different, related to each other by an overall balancing condition for force. In addition to the variables defined above, the following terms are defined for the three components (such terms can be extended for models with more than three components):
N=Axial Force
M=Moment Acting on a Component
Fₛ=Side Force acting on a Component
L₁, L₂, L₃=Distance between components
e₁, e₂, e₃=Displacement of components from wellbore center
e_{ec}=Eccentricity of the eccentric component
K₁, K₂, K₃=Stiffness of the components
Θ=Bending angle
Rₚ=Outer Radius of Component
Rₒ=Inner Radius of Casing
μ=Coefficient of friction
F_{f}=Total Friction Force acting on the String

EI=Bending Stiffness of components
v₁, v₂=Side deformation at the concentric components
v_{ec}=Side deformation at the eccentric component

FIG. 4 shows a representation of displacements of three components experiencing a side force. The three components are located at positions A, B, and C, where B is separated from C by distance L₂ and B is separated from A by distance L₁. With the definitions given above, the side force Fₛ₂ can be defined by the side forces Fₛ₁ and Fₛ₃ at positions A and C, respectively, from balancing of the forces. In this three component analysis, the steel component can be modeled as having infinite stiffness such that K₁=K₂=K₃. The modeling herein also can include modeling the string as being steel as modeled for the component, no deformation in a component, no deformation in an axial direction, and small contact areas/thin components. The side forces can be defined by the side forces Fₛ₁, Fₛ₂, and Fₛ₃, which can be given by:

Fₛ₁=(EI/L₁³)(e₂−e₁)−(EI/L₁²)θ₂

Fₛ₃=(EI/L³₂)(e₂−e₃)−(EI/L₁²)θ₂

Fₛ₂=−Fₛ₁−Fₛ₃

Methods, discussed herein, provide a mechanism to estimate the side force under these various conditions. It can also provide an estimation of the minimum displacements between the components. The calculations associated with the methods can include complex equations. Processing of these equations can be performed to solve the equations to obtain the side force, drag force, and minimum displacement.

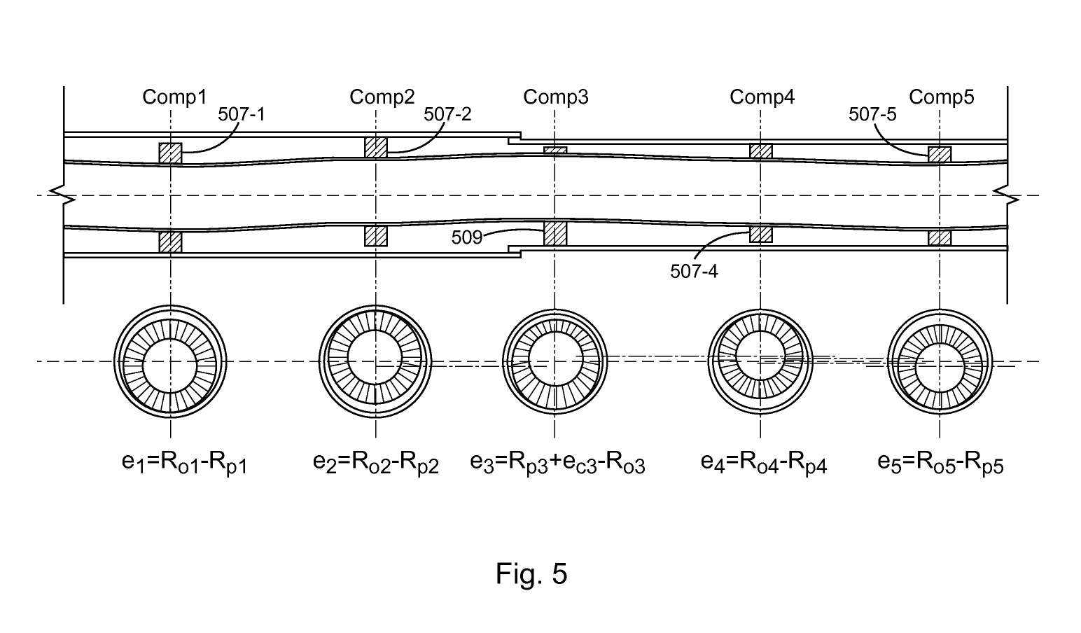

FIG. 5 shows a five component model in which an eccentric component 509 is located as a center component in the sequence of components with symmetric components 507-1 and 507-2 on one side of the eccentric component 509 and symmetric components 507-4 and 507-5 on the other side of the eccentric component 509. Each component has a displacement from the wellbore center expressed in terms of Rₚ and Rₒ of the respective component. The eccentric component 509 includes an additional term due to its eccentricity.

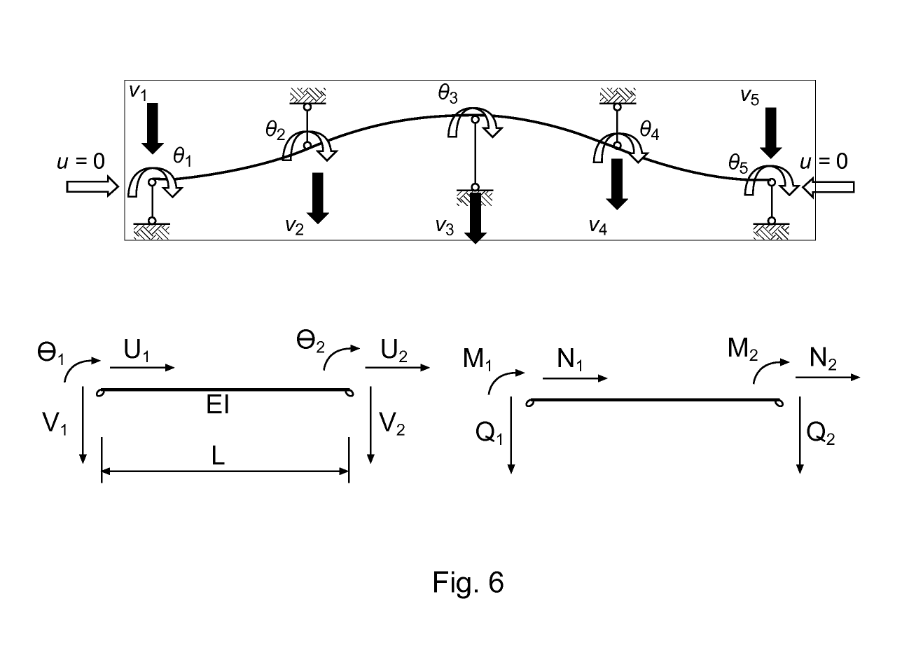

FIG. 6 shows a representation of the model of FIG. 5 with respect to bending angle of the completion string at each component. The axial deformation u is neglected by taking u to be equal to zero. The completion string can be analyzed piecewise considering each length between adjacent components. For each length, the angle or bending can be considered with respect to axial deformation and side deformation, and a moment can be considered for axial force in the length and shear forces at the ends of the length.

For the condition that the sum of the moments equal zero, the following can be obtained:

$$[ \begin{matrix}4 {i}_{1} & 2 {i}_{1} & & & \\ 2 {i}_{1} & 4 ( {i}_{1} + {i}_{2} ) & 2 {i}_{2} & & \\ & 2 {i}_{2} & 4 ( {i}_{2} + {i}_{3} ) & 2 {i}_{3} & \\ & & 2 {i}_{3} & 4 ( {i}_{3} + {i}_{4} ) & 2 {i}_{4} \\ & & & 2 {i}_{4} & 4 {i}_{4 }\end{matrix} ] \{ \begin{matrix}{θ}_{1} \\ {θ}_{2} \\ {θ}_{3} \\ {θ}_{4} \\ {θ}_{5 }\end{matrix} \} = \{ \begin{matrix}- \frac{6 {i}_{1}}{{l}_{1}} ( {v}_{1} - {v}_{2} ) \\ - \frac{6 {i}_{1}}{{l}_{1}} ( {v}_{1} - {v}_{2} ) - \frac{6 {i}_{2}}{{l}_{2}} ( {v}_{2} - {v}_{3} ) \\ - \frac{6 {i}_{2}}{{l}_{3}} ( {v}_{2} - {v}_{3} ) - \frac{6 {i}_{3}}{{l}_{3}} ( {v}_{3} - {v}_{4} ) \\ - \frac{6 {i}_{3}}{{l}_{3}} ( {v}_{2} - {v}_{3} ) - \frac{6 {i}_{3}}{{l}_{2} } ( {v}_{4} - {v}_{5} ) \\ \frac{6 {i}_{2}}{{l}_{2}} ( {v}_{4} - {v}_{5} )\end{matrix} \}$$

In this equation for j=1, 2, 3, 4, and 5, θⱼ is a bending angle of the completion string at the j^{th} component, vⱼ, is the side deformation of the j^{th} component, and lⱼ is the length between the (j+l)^{th} component and the j^{th} component, and iⱼ=EI/lⱼ. Appropriate analysis for a completion string can be conducted using a model of five or less components.

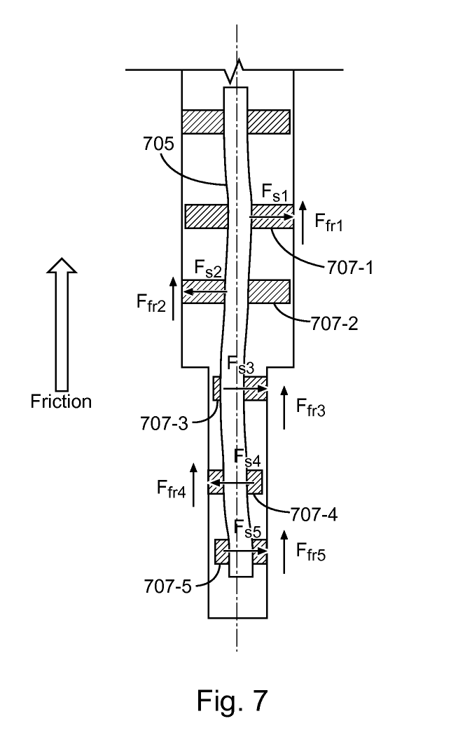

FIG. 7 illustrates friction force in a single direction for a five component model. The five component model includes five components 707-1, 707-2, 707-3, 707-4, and 707-5 for a completion string 705, where at least one of the components is an off-center component. The friction force F_{f} can be calculated as the sum of the friction forces F_{fr1}, F_{fr2}, F_{fr3}, F_{fr4,} and F_{fr5} at the respective component. Each of the friction forces is proportional to a side force Fₛ₁, Fₛ₂, Fₛ₃, Fₛ₄, or Fₛ₅ at the respective component. The friction F_{f} can be given by

F_{f}=μ(|Fₛ₁|+|Fₛ₂|+|Fₛ₃|+|Fₛ₄|+|Fₛ₅|),

where μis the coefficient of friction. This friction force F_{f} calculation can provide a drag force calculation for the completion string 705.

The methods, as taught herein, can be used for failure analysis. The stress in the completion string can be calculated from the modeling. With a maximum stress determined, it can be compared to a stress, σ_{Strength}, that represents the strength of the completion string at which failure is expected to occur. With respect to an axial stress, σ_{A}, maximum bend stress, σ_{Bmax}, maximum shear stress, τₘₐₓ, the maximum total stress, σ, allowable up to σ_{Strength} is given by

σ=Max[σ_{A}+σ_{Bmax}, SQRT(σ_{A}²+τₘₐₓ²)]≦σ_{Strength}.

Continuous monitoring can be performed during drilling and production throughout the life of the well using fiber optic sensors and strain gauges, which can be compared against the analysis using methods similar or identical to methods discussed herein. Such methods can also be used to calculate the casing burst, casing collapse, and safety factors. Embedded strain gauges can be used to measure three axes stresses. Continuous monitoring of von Mises stress can be conducted with respect to the modeling taught herein to check the integrity of the well.

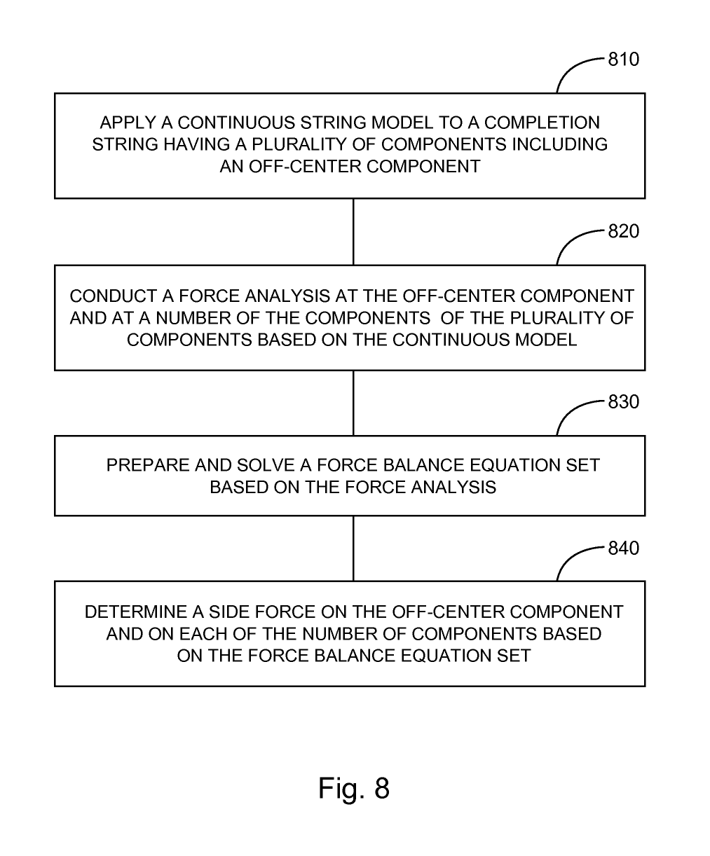

FIG. 8 shows features of an embodiment of an example method of operating a processor to perform a load analysis of a completion string. At 810, a continuous string model is applied to a completion string having a plurality of components including an off-center component. Applying a continuous string model can include applying a five component model. At 820, a force analysis is conducted at the off-center component and at a number of the components of the plurality of components based on the continuous model. At 830, a force balance equation set is prepared and solved based on the force analysis. At 840, a side force is determined on the off-center component and on each of the number of components based on the force balance equation set.

The method can include determining a drag force on the completion string based on determining the side forces. The method can include performing a stress analysis on the completion string based on determining the side forces. The method can include using a soft string model, a stiff string model, a finite element model, or a multi-body system model to perform a drag force analysis or a stress analysis. The method can include determining a minimum displacement between components of the completion string based whether a failure criterion is satisfied based on determining the side force on the off-center component and on each of the number of components. Determining the minimum displacement can include an iterative process in which distance between components of the completion string is increased in the continuous string model until the failure criterion is met.

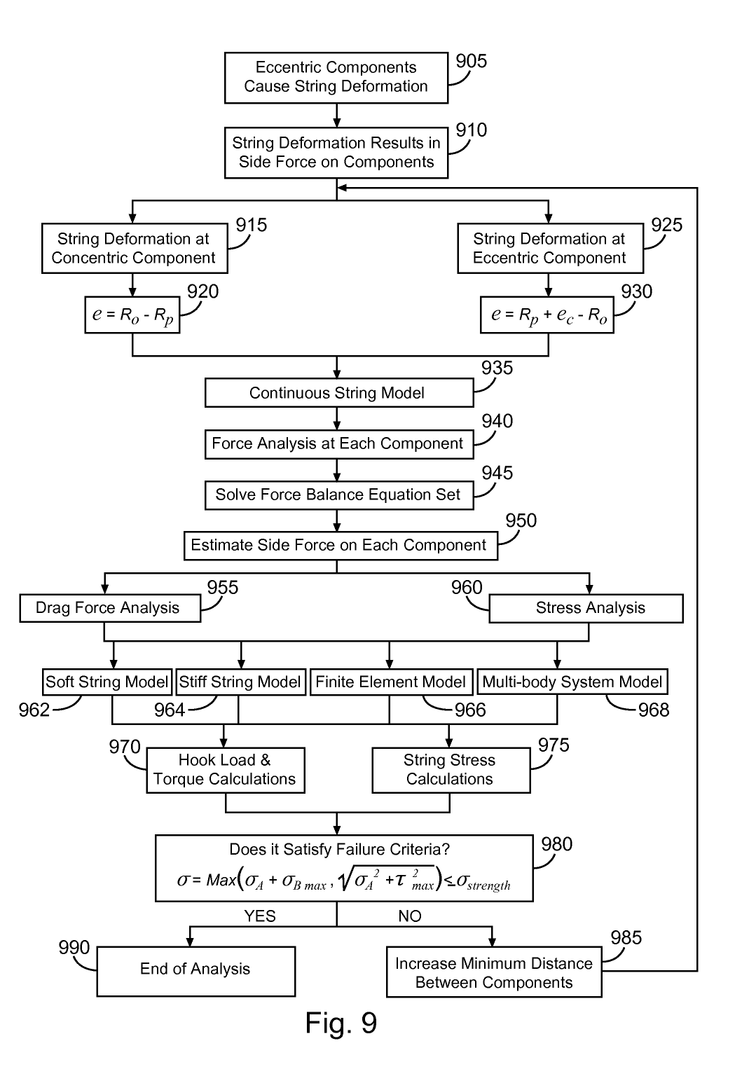

FIG. 9 shows features of an embodiment of an example overview approach to analysis of a component string to determine a minimum displacement of the components. At 905, eccentric components of a component string are identified that can cause string deformation. At 910, side force on components resulting from string deformation can be identified to be evaluated.

At 915, string deformation at concentric component can be identified with the corresponding displacement set as e=Rₒ−Rₚ, at 920. At 925, string deformation at eccentric component can be identified with the corresponding displacement set as e=Rₚ+e_{c}−Rₒ, at 930. At 935, a continuous string model can be applied. At 940, a force analysis can be performed at each component of the continuous string model. At 945, from the force analysis, a force balance equation set can be solved. At 950, a side force on each component can be estimated after solving the force balance equation set. At 955, a drag force analysis can be performed after estimating the side forces. At 960, a stress analysis can be performed after estimating the side forces.

The drag force analysis and the stress analysis can be conducted using one or more of a soft string model at 962, a stiff string model at 964, a finite element model at 966, or a multi-body system model at 968. At 970, hook load & torque calculations can be performed. The hook load is the total net force on a device from which a drillstring, drill collars, or other associated equipment is suspended. At 975, string stress calculations can be performed. At 980, a query can be conducted to determine if the stress satisfies a failure criterion. The failure criterion can be set to

σ=Max[σ_{A}+σ_{Bmax}, SQRT(σ_{A}²+τₘₐₓ²)]≦σ_{Strength},

where σ is the maximum total stress, the stress, σ_{strength}, represents the strength of the component string at which failure is expected to occur, σ_{A} is axial stress, σ_{Bmax} is maximum bend stress, τₘₐₓ is maximum shear stress. At 985, if the criterion is not satisfied, then the minimum distance between components is increased and the analysis is returned to 915 and 925 to determine string deformation for the concentric component and string deformation for the eccentric component at this updated component separation distance. At 990, if the criterion is satisfied, the analysis can be ended.

In various embodiments, a non-transitory machine-readable storage device can comprise instructions stored thereon, which, when performed by a machine, cause the machine to perform operations, the operations comprising one or more features similar to or identical to features of methods and techniques related to perform a load analysis of a completion string described herein. The physical structure of such instructions may be operated on by one or more processors. Executing these physical structures can cause the machine to perform operations to apply a continuous string model to a completion string having a plurality of components including an off-center component; to conduct a force analysis at the off-center component and at a number of the components of the plurality of components based on the continuous model; to prepare and solve a force balance equation set based on the force analysis; and to determine a side force on the off-center component and on each of the number of components based on the force balance equation set. Further, a machine-readable storage device, herein, is a physical device that stores data represented by physical structure within the device. Examples of non-transitory machine-readable storage devices can include, but are not limited to, read only memory (ROM), random access memory (RAM), a magnetic disk storage device, an optical storage device, a flash memory, and other electronic, magnetic, and/or optical memory devices.

In various embodiments, a system can comprise a processor and a memory unit arranged such that the processor and the memory unit are configured to perform one or more operations in accordance with techniques to perform a load analysis of a completion string in a wellbore that are similar to or identical to methods taught herein. The system can include a communications unit to receive data generated from one or more sensors disposed in a wellbore. The one or more sensors can include a fiber optic sensor, a pressure sensor, or a strain gauge to provide monitoring of drilling and production associated with the wellbore. A processing unit may be structured to perform processing techniques similar to or identical to the techniques discussed herein. Such a processing unit may be arranged as an integrated unit or a distributed unit. The processing unit can be disposed at the surface of a wellbore to analyze data from operating one or more measurement tools downhole.

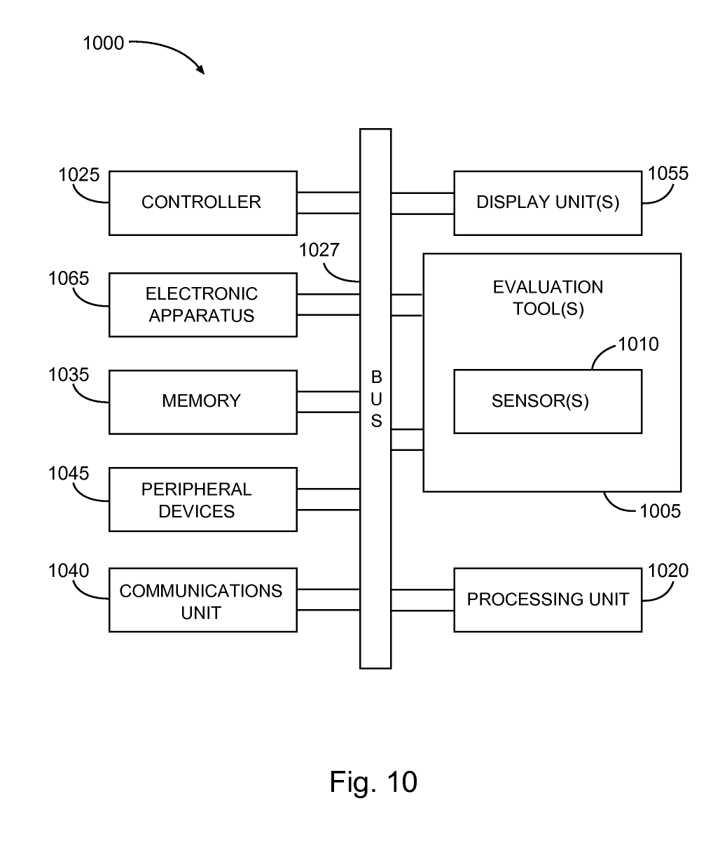

FIG. 10 depicts a block diagram of features of an embodiment of an example system 1000 operable to perform related to perform a load analysis of a completion string or a drill string. The system 1000 can include a controller 1025, a memory 1035, an electronic apparatus 1065, and a communications unit 1040. The controller 1025 and the memory 1035 can be realized to manage processing schemes as described herein. Memory 1035 can be realized as one or more non-transitory machine-readable storage devices having instructions stored thereon, which, when performed by a machine, cause the machine to perform operations, the operations comprising performance of load analysis as taught herein. Processing unit 1020 may be structured to perform the operations to manage processing schemes implementing a load analysis of a completion string or a drill string in a manner similar to or identical to embodiments described herein. The system 1000 may also include one or more evaluation tools 1005 having one or more sensors 1010 operable to make measurements with respect to a wellbore. The one or more sensors 1010 can include, but are not limited to, a fiber optic sensor, a pressure sensor, or a strain gauge to provide monitoring drilling and production associated with the wellbore. The controller 1025 and the memory 1035 can also be arranged to operate the one or more evaluation tools 1005 to acquire measurement data as the one or more evaluation tools 1005 are operated.

Electronic apparatus 1065 can be used in conjunction with the controller 1025 to perform tasks associated with taking measurements downhole with the one or more sensors 1010 of the one or more evaluation tools 1005. The communications unit 1040 can include downhole communications in a drilling operation. Such downhole communications can include a telemetry system.

The system 1000 can also include a bus 1027, where the bus 1027 provides electrical conductivity among the components of the system 1000. The bus 1027 can include an address bus, a data bus, and a control bus, each independently configured. The bus 1027 can also use common conductive lines for providing one or more of address, data, or control, the use of which can be regulated by the controller 1025. The bus 1027 can include optical transmission medium to provide optical signals among the various components of system 1000. The bus 1027 can be configured such that the components of the system 1000 are distributed. The bus 1027 may include network capabilities. Such distribution can be arranged between downhole components such as one or more sensors 1010 of the one or more evaluation tools 1005 and components that can be disposed on the surface of a well. Alternatively, various of these components can be co-located such as on one or more collars of a drill string, on a wireline structure, or other measurement arrangement.

In various embodiments, peripheral devices 1045 can include displays, additional storage memory, and/or other control devices that may operate in conjunction with the controller 1025 and/or the memory 1035. In an embodiment, the controller 1025 can be realized as one or more processors. The peripheral devices 1045 can be arranged to operate in conjunction with display unit(s) 1055 with instructions stored in the memory 1035 to implement a user interface to manage the operation of the one or more evaluation tools 1005 and/or components distributed within the system 1000. Such a user interface can be operated in conjunction with the communications unit 1040 and the bus 1027 and can provide for control and command of operations in response to analysis of the completion string or the drill string. Various components of the system 1000 can be integrated to perform processing identical to or similar to the processing schemes discussed with respect to various embodiments herein.

The methods and systems, as taught herein, provide modeling of side force and drag force while running in multiple off-center components in completion string, which has not been studied before. The method can be used to estimate the minimum distance between two components to prevent failures while running in the off-center completion string. These methods can also be used to estimate the side forces and minimum distance between tools and components in off-center drill strings to prevent any failures during drilling operations. Accurate modeling of the forces and stresses helps to select the appropriate tools and components to prevent overloading and failure of materials in completion strings and avoid losses. An accurate estimation of the minimum distance between components to prevent any failures while running in multiple off-center components in completions strings will help reduce losses.

Although specific embodiments have been illustrated and described herein, it will be appreciated by those of ordinary skill in the art that any arrangement that is calculated to achieve the same purpose may be substituted for the specific embodiments shown. Various embodiments use permutations and/or combinations of embodiments described herein. It is to be understood that the above description is intended to be illustrative, and not restrictive, and that the phraseology or terminology employed herein is for the purpose of description. Combinations of the above embodiments and other embodiments will be apparent to those of skill in the art upon studying the above description.

1. A method comprising:
operating a processor to perform operations including:
applying a continuous string model to a completion string having a plurality of components including an off-center component;
conducting a force analysis at the off-center component and at a number of the components of the plurality of components based on the continuous model;
preparing and solving a force balance equation set based on the force analysis; and
determining a side force on the off-center component and on each of the number of components based on the force balance equation set.

2. The method of claim 1, applying a continuous string model includes applying a five component model.

3. The method of claim 1, wherein the method includes determining a drag force on the completion string based on determining the side forces.

4. The method of claim 1, wherein the method includes performing a stress analysis on the completion string based on determining the side forces.

5. The method of claim 1, wherein the method includes using a soft string model, a stiff string model, a finite element model, or a multi-body system model to perform a drag force analysis or a stress analysis.

6. The method of claim 1, wherein the method includes determining a minimum displacement between components of the completion string based whether a failure criterion is satisfied based on determining the side force on the off-center component and on each of the number of components.

7. The method of claim 6, wherein determining the minimum displacement is an iterative process in which distance between components of the completion string is increased in the continuous string model until the failure criterion is met.

8. A non-transitory machine-readable storage device having instructions stored thereon, which, when performed by a machine, cause the machine to perform operations, the operations comprising:
applying a continuous string model to a completion string having a plurality of components including an off-center component;
conducting a force analysis at the off-center component and at a number of the components of the plurality of components based on the continuous model;
preparing and solving a force balance equation set based on the force analysis; and
determining a side force on the off-center component and on each of the number of components based on the force balance equation set.

9. A system comprising:
a processor; and
a memory unit arranged such that the processor and the memory unit are arranged to:
apply a continuous string model to a completion string having a plurality of components including an off-center component;
conduct a force analysis at the off-center component and at a number of the components of the plurality of components based on the continuous model;
prepare and solve a force balance equation set based on the force analysis; and
determine a side force on the off-center component and on each of the number of components based on the force balance equation set.

10. The system of claim 9, the system includes a communications unit to receive data generated from one or more sensors disposed in a wellbore.

11. The system of claim 10, the one or more sensors include a fiber optic sensor, a pressure sensor, or a strain gauge to provide monitoring drilling and production associated with the wellbore.

12. The system of claim 9, wherein the processor and the memory unit are arranged to apply the continuous string model includes the processor and the memory unit are arranged to apply a five component model.

13. The system of claim 9, wherein the processor and the memory unit are arranged to determine a drag force on the completion string based on the determination of the side forces.

14. The system of claim 9, wherein the processor and the memory unit are arranged to perform a stress analysis on the completion string based on the determination of the side forces.

15. The system of claim 9, wherein the processor and the memory unit are arranged to include use of a soft string model, a stiff string model, a finite element model, or a multi-body system model to perform a drag force analysis or a stress analysis.

16. The system of claim 9, wherein the processor and the memory unit are arranged to determine a minimum displacement between components of the completion string based whether a failure criterion is satisfied based on the determination of side force on the off-center component and on each of the number of components.

17. The system of claim 16, wherein determination of the minimum displacement is an iterative process in which distance between components of the completion string is increased in the continuous string model until the failure criterion is met.

18. The non-transitory machine-readable storage device of claim 8, wherein applying a continuous string model includes applying a five component model.

19. The non-transitory machine-readable storage device of claim 8, wherein the operations include determining a drag force on the completion string based on determining the side forces.

20. The non-transitory machine-readable storage device of claim 8, wherein the operations include performing a stress analysis on the completion string based on determining the side forces.

21. The non-transitory machine-readable storage device of claim 8, wherein the operations include using a soft string model, a stiff string model, a finite element model, or a multi-body system model to perform a drag force analysis or a stress analysis.

22. The non-transitory machine-readable storage device of claim 8, wherein the operations include determining a minimum displacement between components of the completion string based whether a failure criterion is satisfied based on determining the side force on the off-center component and on each of the number of components.

23. The non-transitory machine-readable storage device of claim 22, wherein determining the minimum displacement is an iterative process in which distance between components of the completion string is increased in the continuous string model until the failure criterion is met.
